(19) United States
(12) Patent Application Publication
(10) Pub. No.: US 2007/0131865 A1
(43) Pub. Date: Jun. 14, 2007

(54) Mitigating the effects of misleading characters

(75) Inventors: Eric M. Lawrence, Redmond, WA (US); Venkatraman V. Kudallur, Redmond, WA (US); Roberto A. Franco, Seattle, WA (US); Anthony T. Chor, Bellevue, WA (US); Michel L. Suignard, Bellevue, WA (US); James R. Fox, Seattle, WA (US); Vishu Gupta, Bothell, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/284,421

(22) Filed: Nov. 21, 2005

(51) Int. Cl. G21K 1/02

(52) U.S. Cl. 250/363.1

(57) ABSTRACT

Security identifiers are analyzed to mitigate the use of misleading characters. In some embodiments, a language-based character set determination is utilized and looks for characters that are different from those that a user and/or the user's system would expect to see. If a security identifier is found to contain a character that is other than one that the user or the user's system would expect to see, then certain remedial actions can be implemented

### BACKGROUND

Of the available characters for use in connection with computer-related applications, a number of them from different character sets are similar or identical in appearance. For example, the Cyrillic “a” and the Latin “a” look alike. This can lead to unscrupulous individuals using similar or identically-appearing characters to attempt to dupe unwitting individuals.

### SUMMARY

Security identifiers are analyzed to mitigate the use of misleading characters. In some embodiments, a language-based character set determination is utilized and looks for characters that are different from those that a user and/or the user's system would expect to see. If a security identifier is found to contain a character that is other than one that the user or the user's system would expect to see, then certain remedial actions can be implemented.

### BRIEF DESCRIPTION OF THE DRAWINGS

FIG. 1 is a flow diagram that describes steps in a method in accordance with one embodiment.

FIG. 2 is a flow diagram that describes steps in a method in accordance with one embodiment.

FIG. 3 illustrates an exemplary system in accordance with one embodiment.

FIG. 4 is a flow diagram that describes steps in a method in accordance with one embodiment.

### DETAILED DESCRIPTION

Overview

The various embodiments described below utilize the notion of security identifiers and analyze the security identifiers to mitigate the use of misleading characters. Different types of analysis can be used. For example, in some embodiments, a language-based character set determination is utilized and looks for characters that are different from those that a user and/or the user's system would expect to see. If a security identifier is found to contain a character that is other than one that the user or the user's system would expect to see, then certain remedial actions can be implemented.

One particular implementation that incorporates the use of language in making character set determinations is a locale-based determination. In a locale-based determination, a locale—which can be a combination of a language and a region or simply a location—is used to define a collection of acceptable character sets. If a security identifier is found to contain a character from outside of the acceptable character sets, then certain remedial actions can be implemented.

The principles described in this document can have a wide range of uses with various different types of security identifiers, such as those that are used in universal resource locators (URLs), digital certificates (e.g. certifying authority or organization) and the like. However, to provide but one specific example and to give the reader some tangible context, the inventive principles are described in connection with their use with domain names that form part of a URL. It is to be appreciated and understood that this particular example is not to be used to limit application of the claimed subject matter to domain names only. Rather, other uses can be employed without departing from the spirit and scope of the claimed subject matter.

Mitigating the Effects of Misleading Characters in Domain Names

On the Internet, when a person navigates to a web site they use an address known as an URL. Part of the URL that names the computer that the site is on is called the domain name. The domain name is a mnemonic which is resolved to an IP address that is associated with the computer on which the site is located. As an example, if a user wishes to navigate to a site maintained by Microsoft, they might type into the address bar of their browser “www.” followed by “microsoft.com”. This domain name would then be resolved to an IP address which would be used to navigate the user's browser to the appropriate web site.

Historically, domain names were only permitted to be constructed from a limited number of characters, such as A-Z, a-z, 0-9 and -. Over time, however, there has been a call to support international characters in domain names. As such, the so-called playing field of available characters has grown dramatically. Consider, for example, the full set of Unicode characters in Version 4.1 which contains over 97,000 characters. The maximum encoding space of the Unicode Standard is about 1.1 million code points, most of which are available for encoding of characters in future versions.

Having such a large number of available characters has created a problem known as a homographic attack. In a homographic attack, a domain name which looks legitimate contains letters from different character sets that look similar or identical. For all intents and purposes, the user believes the domain name is legitimate. Yet, the domain name is resolved to a different IP address and hence a different site. This kind of misleading use of international characters can create a very compelling phishing attack in which unscrupulous individuals attempt to acquire sensitive information (such as financial information, social security numbers, etc) from unwitting users.

Against this backdrop however, there is a desire to allow for legitimate uses of international characters in domain names, but at the same time protect users from misleading uses of the international characters.

In the Unicode standard, for example, character sets can by classified by scripts. Examples of scripts include Latin, Greek, Cyrillic, Han, Cherokee and so on. For additional information on the Unicode character database, the reader should refer to the Unicode Standard. Using characters from different scripts, unscrupulous individual can construct a domain name that looks but is not legitimate. For example, by replacing the Latin letters “a” in “paypal.com” with Cyrillic letters “a”, the domain name appears legitimate, yet resolves to a different IP address.

It is to be appreciated and understood that the principles described in this document can be applied outside of the Unicode Standard such as, for example, in connection with DBCS encoding.

Language-Based Character Set Determination

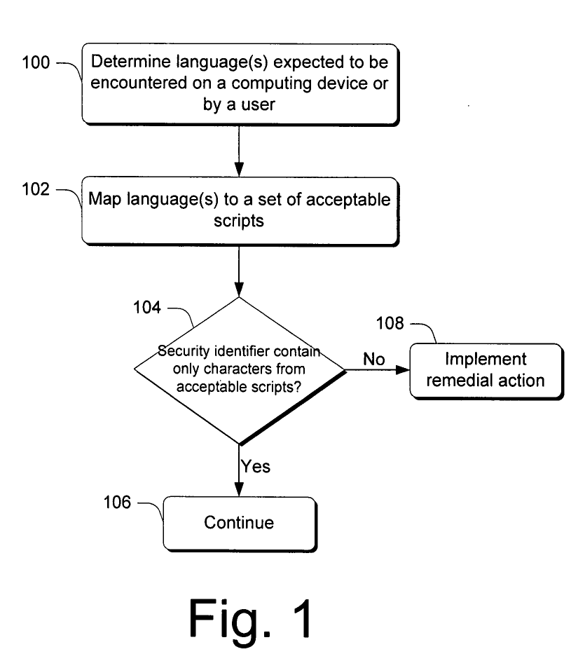

FIG. 1 is a flow diagram that describes steps in a method in accordance with one embodiment. The method can be implemented in connection with any suitable hardware, software, firmware or combination thereof In but one embodiment, the method can be implemented by a browser application executing on a computing device, such as the one illustrated and described below.

Step 100 determines a language(s) expected to be encountered on a computing device or by a user of the computing device. This step can be accomplished a number of different ways. For example, such information may be part of the initial configuration information that is used to configure a user's computing device. Alternately or additionally, the user may be queried as to languages they expect to see or otherwise provide such information. Alternately or additionally, the determination might be made automatically by, for example, determining the location of the computing device and using the device's location to select an appropriate set of languages. One example of how this can be done is discussed in the section just below.

Step 102 maps the language(s) to a set of acceptable scripts. A set may contain one or more scripts. For example, English would map to Latin script; Japanese might map to Han, Katakana and Hiragana, and the like.

Having performed the mapping, step 104 determines whether a security identifier contains only characters from the set of acceptable scripts. In some embodiments in which the security identifier resides in the form of a domain name, the determination would be made with regard to the domain name. Of course, as mentioned above, other security identifiers can be used. If the security identifier contains only characters from the set of acceptable scripts, then step 106 continues in the normal course that would be expected. For example, if the security identifier is embodied in a digital certificate, the normal course might be to continue to allow the user to use whatever resources are associated with the digital certificate. If the security identifier is a domain name, the normal course would be to allow the user to continue their navigation without, perhaps, any warnings.

If, on the other hand, step 104 determines that the security identifier does not contain only characters from allowable scripts, step 108 implements a remedial action. Any suitable type of remedial action can be implemented. For example, a remedial action can include, by way of example and not limitation, presenting a warning dialog for the user. Alternately or additionally, in the domain name context, a remedial action might be to display an encoded form or some other visually distinctive form of the URL of which the domain name is a part. For example, the URL could be shown with the offending characters highlighted with some explanatory text stating, e.g. “all characters are from Latin except the highlighted characters which are from Cyrillic.”

More specifically, in the past in order to facilitate the use of international domain names with systems that do not necessarily understand all of the Unicode scripts, international domains names have been mapped to an equivalent domain name comprised of characters that are understood by these systems. For example, such mappings start with the characters “xn--” followed by a string of other characters. Hence, in this embodiment, if a URL contains a domain name that has characters that are outside the acceptable set of scripts, then the encoded version of the domain name is displayed. This makes it much less likely that a user would be duped into believing that a misleading domain name is a legitimate one. It is to be appreciated and understood that other remedial actions can take place without departing from the spirit and scope of the claimed subject matter.

Locale-Based Determination

One way of implementing a language-based character set determination is to utilize a locale-based determination. A locale can be thought of as being defined by a language and a region. Examples of locales are as follows: English/United States, English/Great Britain, French/Belgium, Russian/Ukraine, Japanese/Japan and the like. Alternately, a locale can be thought of as being simply a location, such as a region or country.

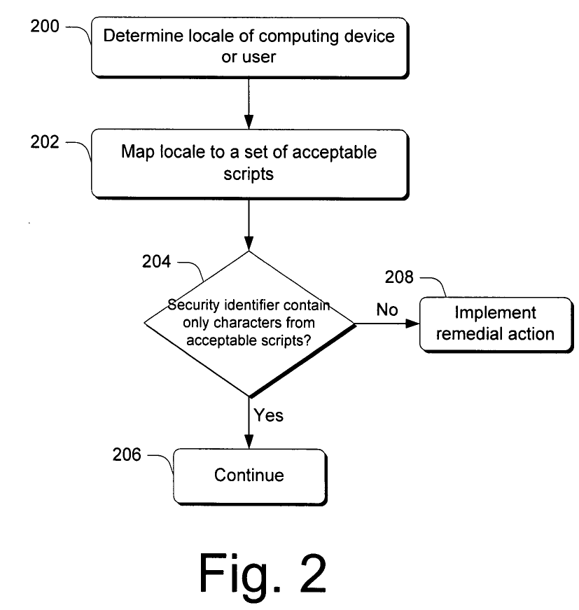

FIG. 2 is a flow diagram that describes steps in a method in accordance with one embodiment. The method can be implemented in connection with any suitable hardware, software, firmware or combination thereof In but one embodiment, the method can be implemented by a browser application executing on a computing device.

Step 200 determines a locale of a computing device or a user. This step can be accomplished a number of different ways. For example, the locale can be pre-configured on a device such as by being part of the device's configuration information. Alternately or additionally, a user may be queried as to their locale or otherwise provide such information. Alternately or additionally, the determination might be made automatically by, for example, using an Internet address lookup. For example, a reverse IP lookup can be utilized to ascertain the user's locale.

Step 202 maps the locale to a set of acceptable scripts. A set may contain one or more scripts. For example, English/United States would map to Latin script; Japanese/Japan would map to Han, Katakana and Hiragana; Russian/Ukraine would map to Cyrillic, and the like.

Having performed the mapping, step 204 determines whether a security identifier contains only characters from the set of acceptable scripts. In some embodiments in which the security identifier resides in the form of a domain name, the determination would be made with regard to the domain name. Of course, as mentioned above, other security identifiers can be used. If the security identifier contains only characters from the set of acceptable scripts, then step 206 continues in the normal course that would be expected. For example, if the security identifier is a domain name, the normal course would be to allow the user to continue their navigation without, perhaps, any warnings. In addition, the domain name might then be displayed in its international unencoded format.

If, on the other hand, step 204 determines that the security identifier does not contain only characters from allowable scripts, step 208 implements a remedial action. Any suitable type of remedial action can be implemented. For example, a remedial action can include, by way of example and not limitation, presenting a warning dialog for the user. Alternately or additionally, in the domain name context, a remedial action might be to display an encoded form of the URL of which the domain name is a part.

### IMPLEMENTATION EXAMPLE

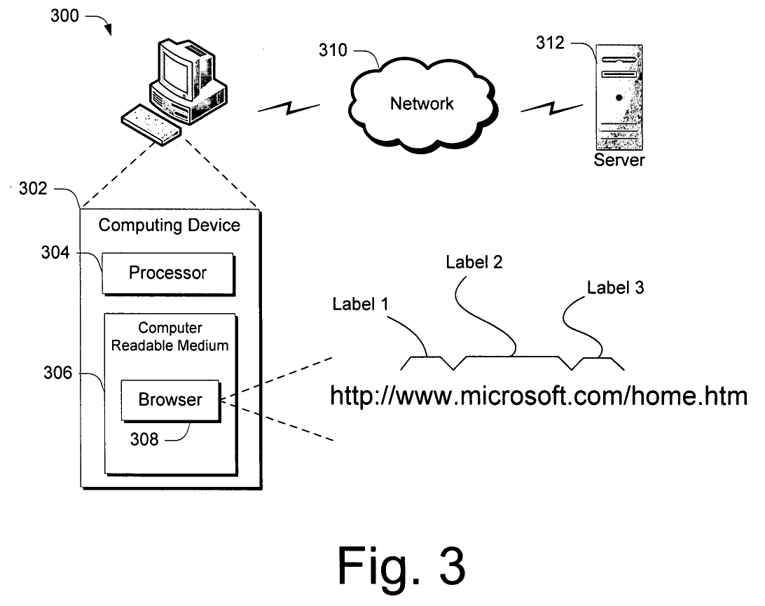

FIG. 3 illustrates, generally at 300, an exemplary system in connection with which various embodiments can be implemented. System 300 includes, in this example, a computing device 302 which can be any suitable computing device such as a desktop or personal computer, portable computer, handheld device and the like. Typically, such computing devices include one or more processors 304, one or more computer-readable media 306 and computer-readable instructions that reside on the media and which are executable by the processor(s) 304. In this example, media 306 embodies multiple different applications one of which residing in the form of browser 308. It is to be appreciated and understood that various applications other than browsers can implement the various embodiments described herein.

In addition, system 300 includes a network, such as the Internet, and a server 312 with which the computing device communicates via network 310.

In this particular example, a domain name is divided up into what are known as labels that are delimited by periods. In the illustration, a first label (Label 1) refers to the “www”, a second label (Label 2) refers to “microsoft” and a third label (Label 3) refers to “com”. In this particular approach, within any particular label only characters from an allowable set of scripts for a single language may appear. That is, each label must contain characters from a single script or from a collection of scripts that occur within a particular language. For example, Japanese is associated with different scripts, all of which can occur within a particular label. In addition, the particular language must be one that is either associated with the computing device or one that the user has chosen.

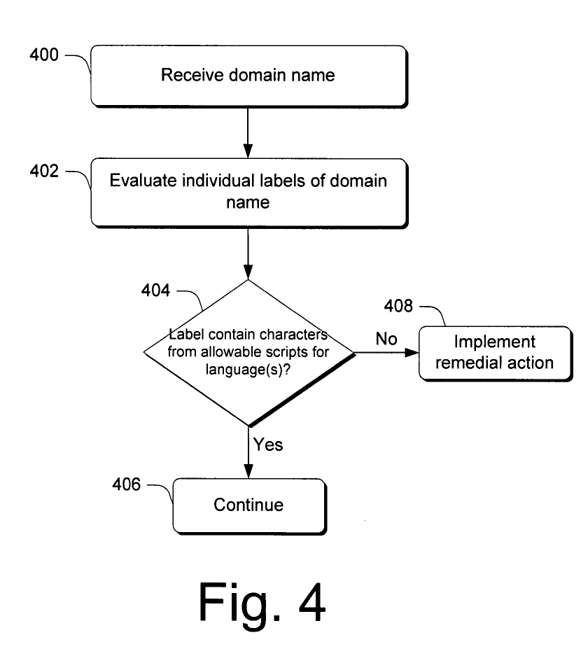

FIG. 4 is a flow diagram that describes steps in a method in accordance with one embodiment. The method can be implemented in connection with any suitable hardware, software, firmware or combination thereof In but one embodiment, the method can be implemented by a browser application executing on a computing device, such as the one shown and described in FIG. 3.

Step 400 receives a domain name. This step can be performed in any suitable way. For example, the domain name may comprise part of an URL that resides on a web page or one that is received in an email. Step 402 evaluates individual labels of the domain name. Step 404 ascertains whether each label contains characters from allowable scripts for a particular language(s). The particular language(s) can be determined using any of the ways described above, e.g. based on a locale, user-provided, automatically determined and the like.

If the labels contain characters from allowable scripts, then step 406 continues in the normal course that would be expected. This can include displaying the international domain name in its unencoded format. If, on the other hand, the labels do not contain characters from allowable scripts, then step 408 implements a remedial action. Examples of remedial actions are given above and can include presenting a warning dialog, displaying an encoded version of the domain name and the like.

### CONCLUSION

By looking for and protecting against the misleading use of characters, the various embodiments can provide an additional level of protection for users.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer-implemented method comprising:
determining one or more languages expected to be encountered on a computing device;
mapping the one or more languages to a set of acceptable character sets;
determining whether a security identifier contains only characters from the set of acceptable character sets; and
implementing a remedial action if the security identifier contains characters other than those from the set of acceptable character sets.

2. The method of claim 1, wherein the act of determining one or more languages is performed based on one or more languages a user of the computing device expects to encounter.

3. The method of claim 1, wherein the character sets comprise Unicode scripts.

4. The method of claim 1, wherein the security identifier comprises a domain name.

5. The method of claim 4, wherein the act of implementing is performed by displaying the domain name in a visually-distinctive manner.

6. The method of claim 5, wherein the visually-distinctive manner comprises an encoded format.

7. The method of claim 1, wherein the security identifier does not comprise a domain name.

8. The method of claim 1, wherein the act of determining one or more languages is performed by using a locale-based determination.

9. A computer-implemented method comprising:
determining a locale associated with a computing device;
mapping the locale to a set of acceptable Unicode scripts;
determining whether a domain name contains only characters from the set of acceptable scripts;
in an event that the domain name contains characters other than those from the set of acceptable scripts, displaying the domain name in a visually-distinctive manner.

10. The method of claim 9, wherein the act of displaying is performed by displaying the domain name in an encoded format different from its Unicode representation.

11. The method of claim 9, wherein the act of determining the locale comprises using both a language and a region.

12. The method of claim 9, wherein the act of determining the locale comprises using a location.

13. The method of claim 9, wherein the act of determining the locale comprises using configuration information on the computing device.

14. The method of claim 9, wherein the act of determining the locale comprises using information provided by a user of the computing device.

15. The method of claim 9, wherein the act of determining the locale comprises doing so without user input as to the locale.

16. A computing device comprising:
one or more processors;
one or more computer-readable media;
computer-readable instructions on the one or more computer-readable media which, when executed by the one or more processors, cause the one or more processors to implement a method comprising:
receiving a domain name;
evaluating individual labels of the domain name to ascertain whether the individual labels contain characters from allowable scripts for a particular language or languages;
in an event a label contains a character from a script that is not an allowable script for the particular language or languages, displaying the domain name in a visually-distinctive manner; and
in an event that all labels contain characters from allowable scripts for the particular language(s), displaying the domain name in an unencoded format.

17. The computing device of claim 16, wherein the computer-readable instructions reside in the form of a browser application.

18. The computing device of claim 16, wherein the particular language or languages are determined using a locale-based approach.

19. The computing device of claim 16, wherein the particular language or languages are determined using information from a user of the computing device.

20. The computing device of claim 16, wherein the act of displaying comprises displaying the domain name in a visually-distinctive manner comprises displaying the domain name in an encoded format.
